(19) United States
(12) Patent Application Publication
(10) Pub. No.: US 2017/0188394 A1
(43) Pub. Date: Jun. 29, 2017

(54) METHOD OF ASSIGNING AND TRANSFERRING SLOT FOR SELF-ORGANIZED TIME DIVISION MULTIPLE ACCESS (SOTDMA)

(71) Applicant: Electronics and Telecommunications Research Institute, Daejeon (KR)

(72) Inventor: Hyun Gu HWANG, Daejeon (KR)

(73) Assignee: Electronics and Telecommunications Research Institute, Daejeon (KR)

(21) Appl. No.: 15/379,684

(22) Filed: Dec. 15, 2016

(30) Foreign Application Priority Data
Dec. 28, 2015 (KR) 10-2015-0187458
Jun. 14, 2016 (KR) 10-2016-0073863

(51) Int. Cl. H04W 74/08; H04W 74/00; H04L 5/22

(52) U.S. Cl. CPC H04W 74/0875; H04L 5/22; H04W 74/004; H04W 74/006

(57) ABSTRACT

Provided is a method of assigning a slot, the method including transmitting an assignment request for at least one slot of a first frame to a terminal, determining whether an acknowledgement (ACK) of the assignment request is received from the terminal, in a slot corresponding to the at least one slot in a second frame which is a subsequent frame of the first frame, and determining whether the at least one slot for which the assignment request is transmitted has been assigned based on whether the ACK of the assignment request is received.

### CROSS-REFERENCE TO RELATED APPLICATION(S)

This application claims the priority benefit of Korean Patent Application No. 10-2015-0187458 filed on Dec. 28, 2015, and Korean Patent Application No. 10-2016-0073863 filed on Jun. 14, 2016, in the Korean Intellectual Property Office, the disclosures of which are incorporated herein by reference for all purposes.

### BACKGROUND

1. Field

One or more example embodiments relate to a method of assigning and transferring a slot for self-organized time division multiple access (SOTDMA).

2. Description of Related Art

In a recent maritime communication system, new channels have been assigned.

Two 25-kHz channels have been assigned next to the existing automatic identification system (AIS) 1 channel and the existing AIS 2 channel as exclusive channels for predetermined application specific message (ASM).

FIG. 1 illustrates assignment of AIS channels and ASM channels. Referring to FIG. 1, an ASM 1 channel and an ASM 2 channel are assigned next to an AIS 1 channel and an AIS 2 channel.

Currently, only the two AIS channels with center frequencies of 161.975 MHz and 162.025 MHz have been internationally assigned for common use.

A bandwidth of each of the AIS channels is 25 kHz. Here, the ASM channels with center frequencies of 161.950 MHz and 162 MHz have been newly assigned. A bandwidth of each of the ASM channels is also 25 kHz.

Meanwhile, the AIS has been commercialized and is currently in use to help with maritime safety. The international maritime organization (IMO) is currently discussing specific communication schemes using SOTDMA after assigning channels for an ASM communication system. In particular, a slot assignment scheme using SOTDMA in the ASM channels has not been determined yet.

ASM is a data message directed to a predetermined user, and thus requires an acknowledgement (ACK). Since an ASM channel uses a narrow channel bandwidth of 25 kHz, a data transmission rate of the ASM channel is overly low, and thus a process of transmitting and receiving an ACK efficiently is needed.

An automatic repeat request (ARQ) is used to recognize an occurrence of error in data transmission and retransmit data. When an error occurs in a scheme such as Go-Back-N ARQ, a reception end transmits a negative acknowledgement (NAK)

However, the scheme of transmitting a NAK when an error occurs is available only for a case of dual communication is available. The ASM uses half duplex communication, and thus may not be transmitted and received simultaneously. Further, a separate slot is needed to transmit an ACK to perform the ARQ.

When a slot for ACK is to be additionally assigned, the process of assigning a slot may be complex. In particular, since SOTDMA uses time division duplex (TDD) half duplex communication, the complex ACK transmitting process may decrease communication efficiency.

### SUMMARY

To solve the aforementioned technical problems, the present disclosure is directed to increasing a rate of channel use by providing a method of assigning a slot for self-organized time division multiple access (SOTDMA).

Meanwhile, the technical tasks obtainable from the present disclosure are non-limited by the above-mentioned technical tasks. And, other unmentioned technical tasks can be clearly understood from the following description by those having ordinary skill in the technical field to which the present disclosure pertains.

According to an aspect, there is provided a method of assigning a slot, the method including transmitting an assignment request for at least one slot of a first frame to a terminal, determining whether an acknowledgement (ACK) of the assignment request is received from the terminal, in a slot corresponding to the at least one slot in a second frame which is a subsequent frame of the first frame, and determining whether the at least one slot for which the assignment request is transmitted has been assigned based on whether the ACK of the assignment request is received.

The ACK of the assignment request may include a number of data having normal cyclic redundancy check (CRC) results and sequence numbers of the data having normal CRC results.

The method may further include transmitting a slot return signal to the terminal, in a slot corresponding to a slot determined to have not been assigned in a third frame which is a subsequent frame of the second frame.

The method may further include determining whether at least one of slots determined to have been assigned is to be used continuously, and transmitting a slot return signal to the terminal in at least one slot determined not to be used continuously.

The transmitting may include transmitting data along with the assignment request for the slot, the determining of whether the ACK of the assignment request is received may include determining whether an ACK of the data is received, and the method may further include determining whether the data has been successfully transmitted based on whether the ACK of the data is received.

The method may further include retransmitting, to the terminal, data determined to have not been transmitted, in a slot determined to have been assigned.

The method may further include transmitting, to the terminal, slot information related to a slot for which an ACK of an assignment request is received, determining whether an ACK of the slot information is received, and determining whether the slot information has been successfully transmitted based on whether the ACK of the slot information is received.

The method may further include, in response to determination that the slot information has not been transmitted, retransmitting the slot information to the terminal, in a slot determined to have been assigned.

The method may further include storing the slot information related to the slot for which the ACK of the assignment request is received.

The method may further include transmitting, to the terminal, a return request for at least one of slots determined to have been assigned, in a slot determined to have been assigned, determining whether an ACK of the return request is received, and determining whether the return request has been successfully transmitted based on whether the ACK of the return request is received.

The method may further include, in response to determination that the return request has not been transmitted, retransmitting the return request to the terminal, in the slot determined to have been assigned.

The method may further include, in response to determination that the return request has been transmitted, transmitting a slot return signal to the terminal, in the at least one slot for which the return request is transmitted.

The method may further include transmitting an additional assignment request for at least one slot of a fourth frame which is a subsequent frame of the third frame, determining whether an ACK of the additional assignment request is received from the terminal, in a slot corresponding to the at least one slot for which the additional assignment request is transmitted in a fifth frame which is a subsequent frame of the fourth frame, and determining whether the at least one slot for which the additional assignment request is transmitted has been additionally assigned based on whether the ACK of the additional assignment request is received.

The method may further include transmitting a slot return signal to the terminal, in a slot corresponding to a slot determined to have not been additionally assigned in a sixth frame which is a subsequent frame of the fifth frame.

The method may further include, in response to determination that the return request has been transmitted, determining whether a slot transfer request is received, and determining whether the at least one slot for which the return request is transmitted is to be transferred based on whether the slot transfer request is received.

The method may further include, in response to determination that the at least one slot for which the return request is transmitted is to be transferred, transmitting an ACK of the slot transfer request to the terminal.

The method may further include, in response to determination that the at least one slot for which the return request is transmitted is not to be transferred, transmitting a slot return signal to the terminal, in the at least one slot for which the return request is transmitted.

According to another aspect, there is also provided a method of transferring a slot, the method including receiving a return request for at least one slot, transmitting, to a terminal, a slot transfer request for at least one of slots for which return requests are received, determining whether an ACK of the slot transfer request is received, and determining whether the slot transfer request has been successfully transmitted based on whether the ACK of the slot transfer request is received.

The method may further include, in response to determination that the slot transfer request has not been transmitted, retransmitting the slot transfer request to the terminal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates assignment of international automatic identification system (AIS) channels and application specific message (ASM) channels;

FIG. 2 illustrates a configuration of a frame according to an example embodiment;

FIGS. 3A and 3B illustrate processes of a first terminal requesting and receiving an acknowledgement (ACK) from a second terminal according to an example embodiment;

FIG. 4A is a flowchart illustrating a method of assigning a slot to a terminal according to an example embodiment;

FIGS. 4B and 4C illustrate processes of assigning a slot to a terminal according to an example embodiment;

FIG. 5A is a flowchart illustrating a method of assigning a slot to a terminal and returning the slot according to an example embodiment;

FIGS. 5B and 5C illustrate processes of assigning a slot to a terminal and returning the slot according to an example embodiment;

FIG. 6A is a flowchart illustrating a method of assigning a plurality of slots to a terminal according to an example embodiment;

FIG. 6B illustrates a process of assigning a plurality of slots to a terminal according to an example embodiment;

FIG. 6C illustrates a process of transmitting a plurality of items of data along with assignment requests for a plurality of slots from a terminal according to an example embodiment;

FIG. 6D illustrates a case in which an error occurs when a terminal transmits a plurality of items of data along with assignment requests for a plurality of slots according to an example embodiment;

FIG. 7A is a flowchart illustrating a method of returning an assigned slot after a plurality of slots are assigned to a terminal according to an example embodiment;

FIG. 7B illustrates a process of returning an assigned slot after a plurality of slots are assigned to a terminal according to an example embodiment;

FIG. 8A is a flowchart illustrating a method of additionally assigning a slot to a terminal according to an example embodiment;

FIG. 8B illustrates a process of additionally assigning a slot to a terminal according to an example embodiment;

FIG. 9A is a flowchart illustrating a method of transferring an assigned slot from a first terminal to a second terminal according to an example embodiment;

FIG. 9B is a flowchart illustrating a method of transferring a slot from a first terminal to a second terminal according to an example embodiment;

FIG. 9C illustrates a process of transferring a slot assigned to a first terminal to a second terminal according to an example embodiment; and

FIG. 10 is a block diagram illustrating a computing system performing a method of assigning a slot according to an example embodiment.

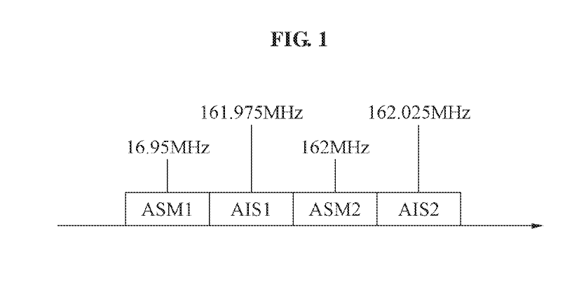

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

The terms such as first, second, A, B, (a), (b), and the like may be used herein to describe components. Each of these terminologies is not used to define an essence, order or sequence of a corresponding component but used merely to distinguish the corresponding component from other component(s). Further, unless specifically defined, all the terms used herein including technical or scientific terms have the same meaning as terms generally understood by those skilled in the art. Terms defined in a general dictionary should be understood so as to have the same meanings as contextual meanings of the related art. Unless definitely defined herein, the terms are not interpreted as ideal or excessively formal meanings.

Herein, a method of assigning and transferring a slot will be described on the premise that self-organized time division multiple access (SOTDMA) is used in an application specific message (ASM) channel. However, the method of assigning and transferring a slot is not limited to the ASM channel, and may also be applied to another channel using SOTDMA, for example, an automatic identification system (AIS) channel.

Prior to describing a method of assigning a slot according to an example embodiment, an ASM channel will be described below.

In an existing AIS, an ASM is a type of message. However, an ASM channel has been currently assigned by assigning frequencies for ASM. Thus, the ASM channel is configured using SOTDMA, which is recommended by the international organization.

As in an AIS channel, a terminal is assigned with and returns a slot within a single frame of an ASM channel. For this, when the terminal occupies a slot in the ASM channel, the terminal indicates whether to use the slot continuously in a subsequent frame.

Herein, it is assumed that indication of whether to use the slot continuously, hereinafter, a C bit, in a subsequent frame is also performed in the ASM channel. Here, a C bit of “1” indicates continuous use, and a C bit of “0” indicates non-use.

Meanwhile, a frame time standard for the ASM channel has not been determined yet. Thus, herein, a frame time is assumed as two seconds. Further, it is assumed that 75 slots are included in a single ASM channel. Thus, two ASM channels include 150 slots. However, the frame time is not limited thereto, and may be four seconds, six seconds, or eight seconds.

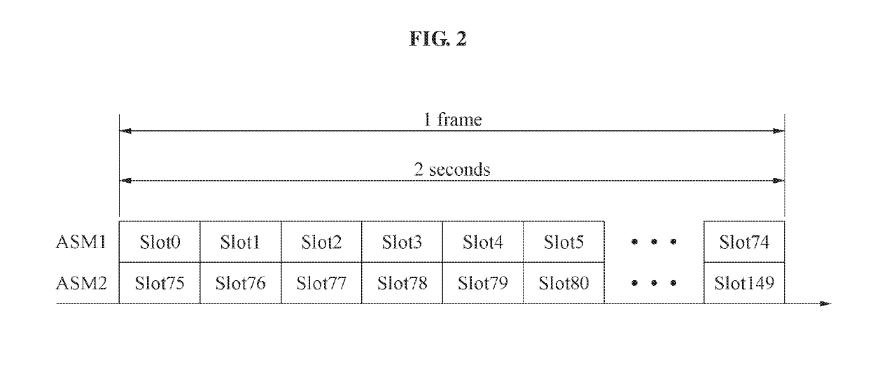

FIG. 2 illustrates a configuration of a two-second frame according to an example embodiment. Referring to FIG. 2, a channel 1 includes 75 channels and a channel 2 includes 75 channels, and thus there are a total of 150 channels. Slot numbers 0 to 74 may be assigned to the slots of the channel 1, and slot numbers 75 to 149 may be assigned to the slots of the channel 2.

Hereinafter, to describe a method of assigning a slot according to an example embodiment, a terminal requesting slot assignment is referred to as a first terminal 100, and a terminal assigning a slot is referred to as a second terminal 200.

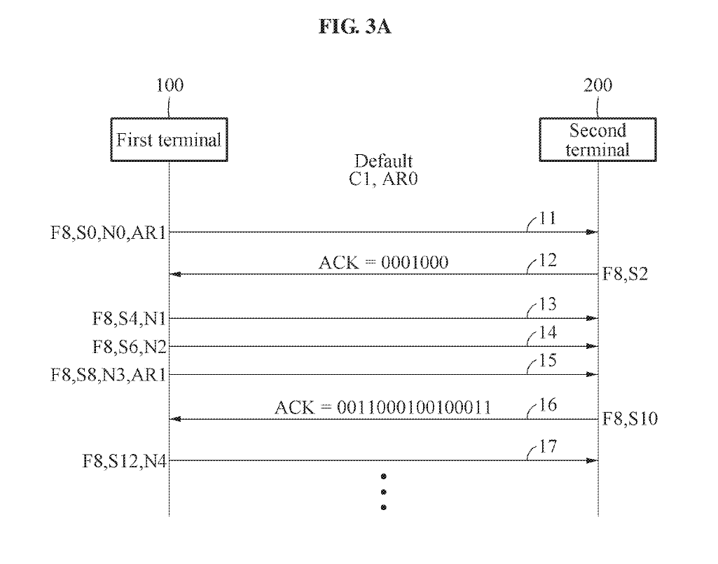

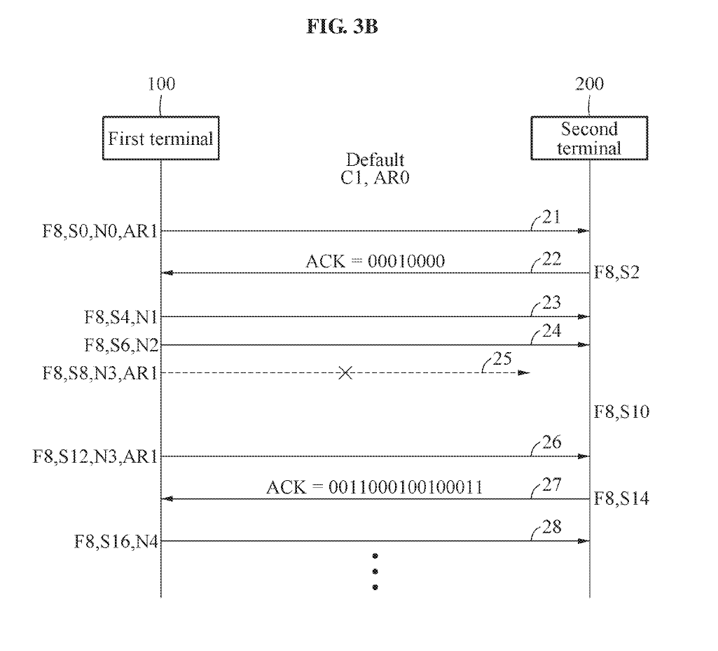

FIGS. 3A and 3B illustrate processes of the first terminal 100 requesting and receiving an acknowledgement (ACK) from the second terminal 200 according to an example embodiment.

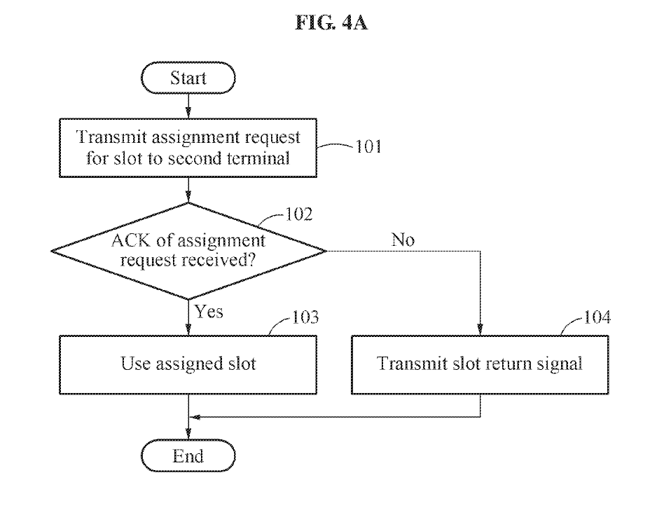

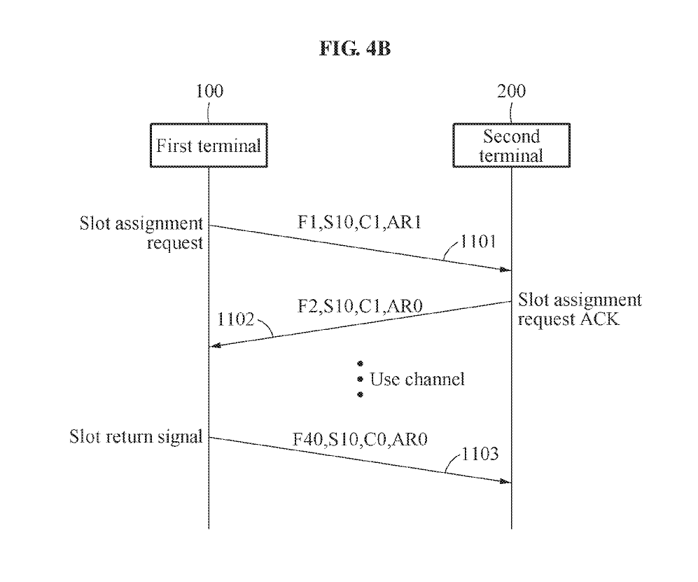

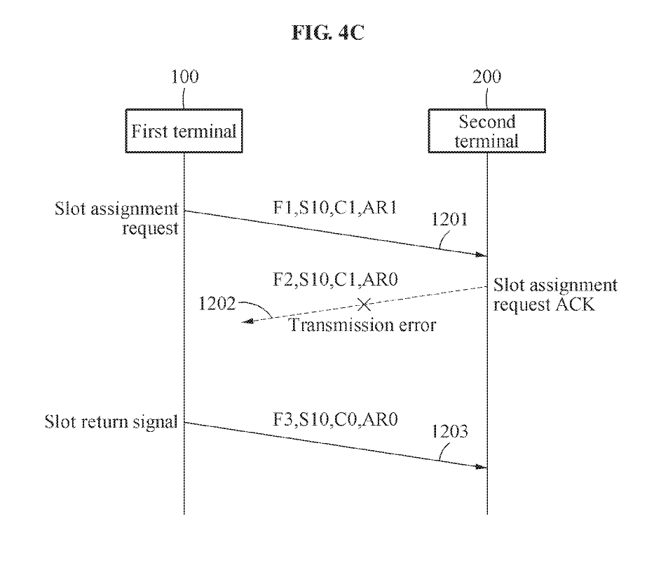

In FIGS. 3A and 3B, F denotes a frame number, S denotes a slot number, C denotes a C bit which indicates whether to use the slot continuously, AR denotes an ACK request bit, and N denotes a sequence number of data. In addition to FIGS. 3A and 3B, unless otherwise indicated with respect to the C bit indicating whether to use the slot continuously and a bit AR requesting an ACK, it may also be assumed that a value of the C bit is “1” and a value of the AR is “0” in FIGS. 4A through 9C.

In SOTDMA, to request an ACK from the second terminal 200, the first terminal 100 transmits a signal to the second terminal 200 by indicating an AR as “1” in a slot. The second terminal 200 receives the signal. When the AR is “1”, the second terminal 200 transmits an ACK of the signal to the first terminal 100. When the AR is “0”, the second terminal 200 does not transmit the ACK.

In the present example embodiment, it is assumed that the first terminal 100 is assigned with even-numbered slots S0, S2, S4, S6, S8, S10, S12, S14, and S16.

Referring to FIG. 3A, in operation 11, the first terminal 100 transmits data by indicating an ACK request (AR) bit as “1” in the slot S0. In operation 12, the second terminal 200 transmits an ACK in the slot S2.

In operation 13, 14, and 15, the first terminal 100 transmits data in the slots S4, S6, and S8. In this example, the AR is “0” in the slots S4 and S6, and the AR is “1” in the slot S8.

The second terminal 200 does not transmit ACKs when the data is received in the slots S4 and S6. In operation 16, the second terminal 200 transmits an ACK in the slot S10 after receiving the data in the slot S8. When transmitting the ACK after receiving the data in the slot S8, the second terminal 200 ACKs of the data transmitted in the slots S4 and S6.

The ACK transmitted by the second terminal 200 may include a length field indicating a length of the ACK, and sequence numbers of the data received in the three slots. That is, the length field indicating the length of the ACK denotes a number of slots having normal cyclic redundancy check (CRC) results.

The ACK transmitted from the second terminal 200 to the first terminal 100 in the slot S2 is “00010000”. In “00010000”, “0001” denotes “1” which is a length of the ACK transmitted from the second terminal 200 to the first terminal 100, and “0000” denotes “0” which is a sequence number of the data transmitted to the second terminal 200 in the slot S0.

Further, the ACK transmitted from the second terminal 200 in the slot S10 is “0011000100100011”, in which the first four digits “0011” indicates that a number of data having normal CRC results is “3” and sequence numbers of the data are “1” corresponding to “0001”, “2” corresponding to “0010”, and “3” corresponding to “0011”.

FIG. 3B illustrates a case in which an error occurs in data transmission in the slot S8. When an error occurs in the slot S8, the second terminal 200 may not receive an ACK request, and thus does not transmit an ACK in the slot S10.

The first terminal 100 may not receive an ACK in the slot S10, and thus retransmits a signal of the slot S8 in the slot S12 to request an ACK, in operation 26. Accordingly, the second terminal 200 transmits an ACK to the first terminal 100 in the slot S14, in operation 27. In this example, similar to FIG. 3A, the transmitted ACK is “0011000100100011”, which indicates that a number of data having normal CRC results is “3”, and sequence numbers of the data are “1”, “2”, and “3”, respectively.

In a wireless channel using SOTDMA, an ACK field may include a number field indicating a number of data having normal CRC results among received data, and an ACK field indicating sequence numbers of the data having normal CRC results.

Meanwhile, in general, an ASM channel is used to transmit a message to a predetermined terminal. Thus, when the first terminal 100 and a third terminal transmit signals in an S-th slot of an F-th frame to be assigned with the same slot, the second terminal 200 may receive the two signals transmitted from the first terminal 100 and the third terminal. In this example, since it is considered that an error occurs according to CRC results, the second terminal 200 may not transmit an ACK to the first terminal 100.

Thus, when the first terminal 100 requests slot assignment from the second terminal 200, the second terminal 200 transmits an ACK to the first terminal 100 in an S-th slot which is the same slot resource of a subsequent frame. When the first terminal 100 receives the ACK, the slot assignment between the two terminals may be considered as having been successfully performed without collision.

Herein, slot assignment using reception of an ACK is suggested. To use an ACK for slot assignment, the second terminal 200 needs to transmit an ACK in a slot with a slot number same as that of a slot for which an assignment request is transmitted.

Hereinafter, on the premise that reception of an ACK is used for slot assignment, methods of assigning a slot to a terminal in a wireless channel using SOTDMA will be described in detail with reference to FIGS. 4A through 8B.

FIG. 4A is a flowchart illustrating a method of assigning a slot to a terminal according to an example embodiment. FIGS. 4B and 4C illustrate methods of assigning a slot to a terminal according to an example embodiment.

Referring to FIG. 4A, a method of assigning a slot may include operation 101 of transmitting an assignment request for a slot from the first terminal 100 to the second terminal 200, operation 102 of determining whether the first terminal 100 receives an ACK of the assignment request from the second terminal 200, and operation 103 of using the assigned slot when the first terminal 100 receives the ACK of the assignment request or operation 104 of transmitting a slot return signal to the second terminal 200 when the ACK of the assignment request is not received.

In detail, in operation 101, the first terminal 100 may transmit an assignment request for at least one slot of a first frame F1 to the second terminal 200.

When transmitting the assignment request for the slot, the first terminal 100 may indicate information regarding whether to use the slot continuously as continuous use (C1), and request an ACK of the assignment request for the slot (AR1).

The first terminal 100 may transmit assignment requests for a plurality of slots. When transmitting the assignment requests for the plurality of slots, the first terminal 100 may indicate information regarding whether to use the slots continuously as continuous use (C1) in the plurality of slots for which the assignment requests are transmitted, and request ACKs of the assignment requests for the slots (AR1).

In operation 102, the first terminal 100 may determine whether an ACK of the assigning request is received from the second terminal 200 in a slot corresponding to the at least one slot in a second frame F2 which is a subsequent frame of the first frame F1.

A corresponding slot number in the second frame F2 is the same as a slot number of the slot for which the assignment request is transmitted in the first frame F1. For example, in a case in which an assignment request for a slot is transmitted in a slot S2 of the first frame F1, whether an ACK of the assignment request is received in a slot S2 of the second frame F2 may be determined.

When the ACK of the assignment request is received, the first terminal 100 may determine that the slot for which the ACK is received has been assigned, be assigned with the slot for which the ACK is received, and use the assigned slot, in operation 103.

In a case in which the first terminal 100 transmits the assignment requests for the plurality of slots in operation 101 and receives ACKs in a portion of the plurality of slots, the first terminal 100 may determine that the slots for which the ACKs are received have been assigned, be assigned with the slots for which the ACKs are received, and use the assigned slots.

In a case in which the ACK of the assignment request is not received, the first terminal 100 may determine that the slot for which the ACK is not received has not been assigned, and transmit a slot return signal to the second terminal 200, in operation 104.

In a case in which the first terminal 100 transmits the assignment requests for the plurality of slots in operation 101 and does not receive ACKs in a portion of the plurality of slots, the first terminal 100 may determine that the slots for which the ACKs are not received have not been assigned, and transmit slot return signals.

When transmitting the plurality of slot return signals, the first terminal 100 may indicate information regarding whether to use the slots continuously as non-use (C0) in the slots for which the ACKs are not received. Further, in a case in which the ACKs are not received with respect to a plurality of slots, the first terminal 100 may transmit slot return signals by indicating information regarding whether to use the slots continuously as non-use (C0) in the plurality of slots.

Hereinafter, examples of operations 101 through 104 will be described in detail with reference to FIGS. 4B and 4C.

FIG. 4B illustrates a case in which an ACK of an assignment request for a slot is transmitted normally from the second terminal 200 to the first terminal 100 according to an example embodiment.

Referring to FIG. 4B, in operation 1101, the first terminal 100 transmits an assignment request for a slot S10 of a first frame F1 to the second terminal 200 while indicating whether to use the slot continuously as continuous use (C1) and requesting an ACK of the assignment request (AR1).

In operation 1102, the second terminal 200 receiving the assignment request for the slot transmits an ACK of the assignment request for the slot to the first terminal 100 in a slot S10 of a second frame F2 which is a subsequent frame of the first frame F1, while indicating whether to use the slot continuously as continuous use (C1) and not requesting an ACK (AR0).

Since the ACK is received in the slot S10 of the second frame F2, the first terminal 100 determines that the slot S10 has been assigned, is assigned with the slot S10, and uses the slot S10.

After using the slot, the first terminal 100 may return the slot S10 by transmitting a slot return signal, in operation 1103. The first terminal 100 transmits the slot return signal to the second terminal 200 in the slot S10, while indicating whether to use the slot continuously as non-use (C0) and not requesting an ACK (AR0).

FIG. 4C illustrates a case in which an error occurs when the second terminal 200 transmits an ACK of an assignment request for a slot according to an example embodiment.

Referring to FIG. 4C, similar to FIG. 4A, in operation 1201, the first terminal 100 transmits an assignment request for a slot S10 of a first frame F1 to the second terminal 200, while indicating whether to use the slot continuously as continuous use (C1) and requesting an ACK (AR1).

In operation 1202, the second terminal 200 receiving the assignment request for the slot transmits an ACK of the assignment request to the first terminal 100 in a slot S10 of a second frame F2 which is a subsequent frame of the first frame F1, while indicating whether to use the slot continuously as continuous use (C1) and not requesting an ACK (AR0).

In the case of FIG. 4C, unlike FIG. 4B, an error occurs when the second terminal 200 transmits the ACK. Thus, the first terminal 100 determines that an ACK is not received in the slot S10 of the second frame F2.

The first terminal 100 determines that the slot S10 has not been assigned, and transmits a slot return signal in a slot S10 of a third frame F3 which is a subsequent frame of the second frame F2, in operation 1203. The first terminal 100 transmits the slot return signal to the second terminal 200 in the slot S10, while indicating whether to use the slot continuously as non-use (C0) and not requesting an ACK (AR0).

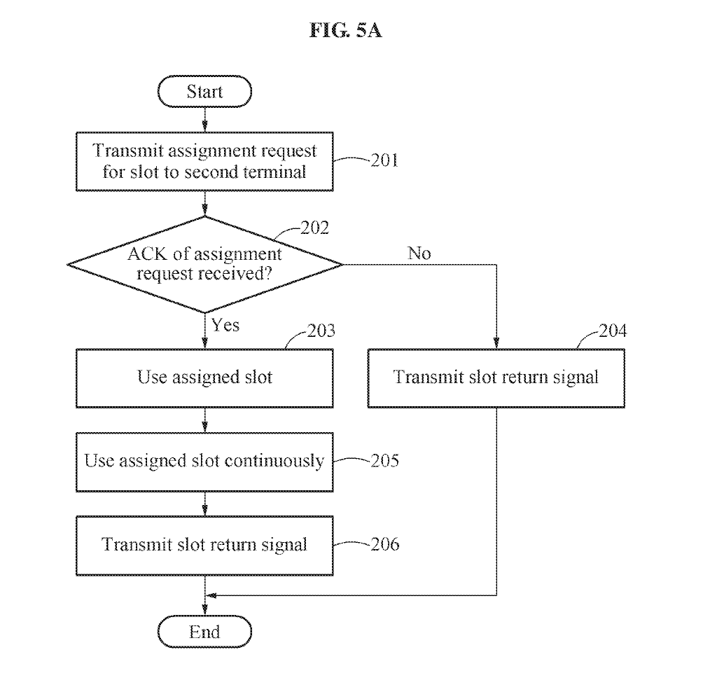

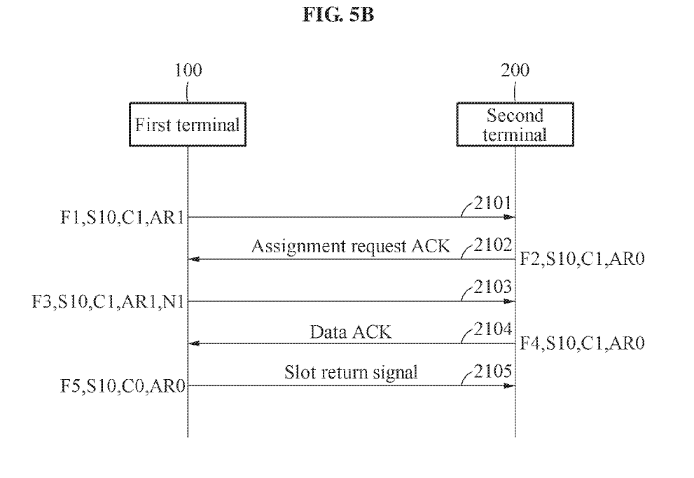

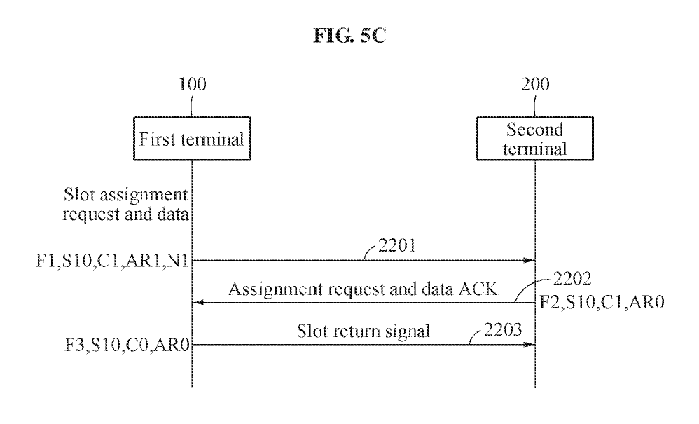

Hereinafter, a method of assigning a slot to a terminal and retuning the assigned slot will be described in detail with reference to FIGS. 5A through 5C.

FIG. 5A is a flowchart illustrating a method of assigning a slot to a terminal and returning the slot according to an example embodiment. FIGS. 5B and 5C illustrate processes of assigning a slot to a terminal and returning the slot according to an example embodiment.

Referring to FIG. 5A, a method of assigning a slot may include operation 201 of transmitting an assignment request for a slot from the first terminal 100 to the second terminal 200, operation 202 of determining whether an ACK of the assignment request is received from the second terminal 200, operation 203 of using the assigned slot when the ACK of the assignment request is received or operation 204 of transmitting a slot return signal to the second terminal 200 when the ACK of the assignment request is not received, operation 205 of determining whether the assigned slot is to be used continuously in a case in which the slot has been assigned, and operation 206 of transmitting a slot return signal to the second terminal 200 in a slot determined not to be used continuously.

That is, the method of assigning and returning a slot of FIG. 5A corresponds to the method of assigning a slot of FIG. 4A further including operation 205 of determining whether the slot is to be used continuously and operation 206 of returning a slot determined not to be used continuously.

Operations 201 through 204 are the same as operations 101 through 104 described above, and thus duplicated descriptions will be omitted for conciseness.

In operation 205, the first terminal 100 may determine whether at least one of assigned slots is to be used continuously.

For example, when the first terminal 100 does not have data to be further transmitted to the second terminal 200, the first terminal 100 may determine that a slot is not to be used continuously.

When the first terminal 100 determines that a slot is to be used continuously, the first terminal 100 may transmit data to the second terminal 200 using the assigned slot continuously.

In operation 206, the first terminal 100 may transmit a slot return signal to the second terminal 200 in at least one slot determined to not be used continuously, among the assigned slots.

The first terminal 100 may transmit the slot return signal by indicating information regarding whether to use the slot continuously as non-use (C0) in a slot determined not to be used continuously. Further, in a case in which a plurality of slots are determined not to be used continuously, the first terminal 100 may transmit slot return signals by indicating information regarding whether to use the slots continuously as non-use (C0) in the plurality of slots.

Hereinafter, examples of operations 201 through 206 will be described in detail with reference to FIGS. 5B and 5C.

FIG. 5B illustrates a case in which the first terminal is assigned with a slot, transmits data, and returns the slot according to an example embodiment.

Referring to FIG. 5B, in operation 2101, the first terminal 100 transmits an assignment request for a slot S10 of a first frame F1 to the second terminal 200, while indicating whether to use the slot continuously as continuous use (C1) and requesting an ACK of the assignment request (AR1).

In operation 2102, the second terminal 200 receiving the assignment request for the slot transmits an ACK of the assignment request for the slot to the first terminal 100 in a slot S10 of a second frame F2 which is a subsequent frame of the first frame F1, while indicating whether to use the slot continuously as continuous use (C1) and not requesting an ACK (AR0).

The first terminal 100 determines that the ACK is received in the slot S10 of the second frame F2, and thus determines that the slot S10 has been assigned and is assigned with the slot S10.

In operation 2103, the first terminal 100 transmits data to the second terminal 200 in the assigned slot S10.

When transmitting the data, the first terminal 100 indicates whether to use the slot continuously as continuous use (C1) and requests an ACK of the data (AR1).

In operation 2104, the second terminal 200 transmits an ACK of the data to the first terminal 100 in the slot S10.

In operation 2105, since the first terminal 100 does not have data to be further transmitted, the first terminal 100 determines that the slot S10 is not to be used continuously and returns the slot S10 by transmitting a slot return signal.

The first terminal 100 transmits the slot return signal to the second terminal 200 in the slot S10, while indicating whether to use the slot continuously as non-use (C0) and not requesting an ACK (AR0).

FIG. 5C illustrates a case in which the data transmitted in a separate frame in the case of FIG. 5B is transmitted along with an assignment request for a slot according to an example embodiment.

Referring to FIG. 5C, in operation 2201, the first terminal 100 transmits an assignment request for a slot S10 of a first frame F1 and data to the second terminal 200, while indicating whether to use the slot continuously as continuous use (C1) and requesting an ACK (AR1).

In this example, the requested ACK may include an ACK of the assignment request for the slot and an ACK of the data.

In operation 2202, the second terminal 200 receiving the assignment request for the slot and the data transmits ACKs of the assignment request for the slot and the data to the first frame 100 in a slot S10 of a second frame F2 which is a subsequent frame of the first frame F1, while indicating whether to use the slot continuously as continuous use (C1) and not requesting an ACK (AR0).

The first terminal 100 determines that the ACK is received in the slot S10 of the second frame F2, and thus determines that the slot S10 has been assigned and is assigned with the slot S10. Further, since the ACK of the data is received, the first terminal 100 determines that the data has been normally transmitted, and may not retransmit the data. A case in which the first terminal 100 retransmits the data based on whether the ACK of the data is received will be described further below.

In operation 2203, since the first terminal 100 does not have data to be further transmitted, the first terminal 100 determines that the slot S10 is not to be used continuously, and returns the slot S10 by transmitting a slot return signal.

As described above, by transmitting data along with an assignment request for a slot, the slot may be used efficiently.

A method of assigning a single slot to the first terminal 100 is useful to transmit a relatively short message. However, when transmitting a relatively long message, the method requires a relatively long time to transmit the message and a complex process. Thus, hereinafter, a method of assigning a plurality of slots and transmitting data will be described.

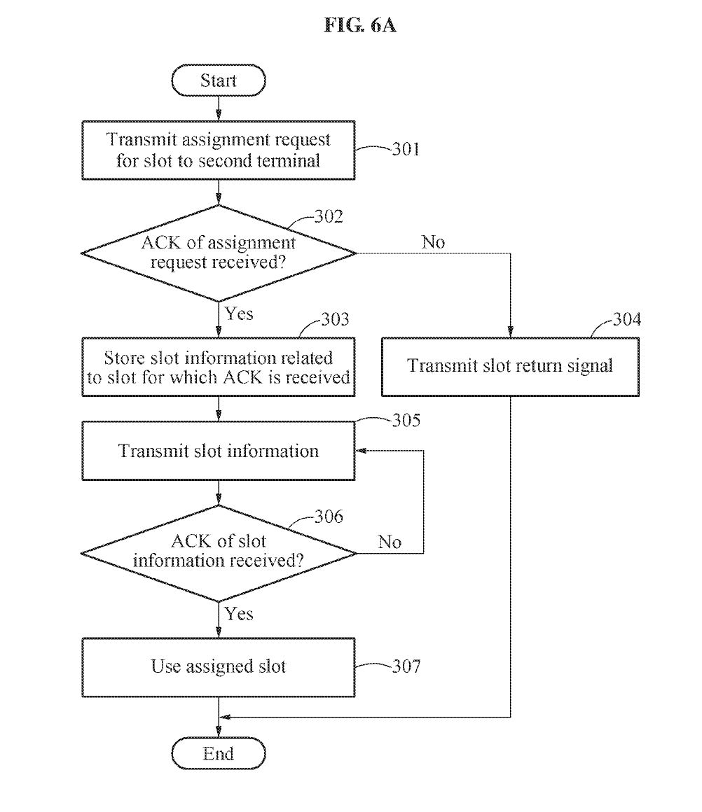

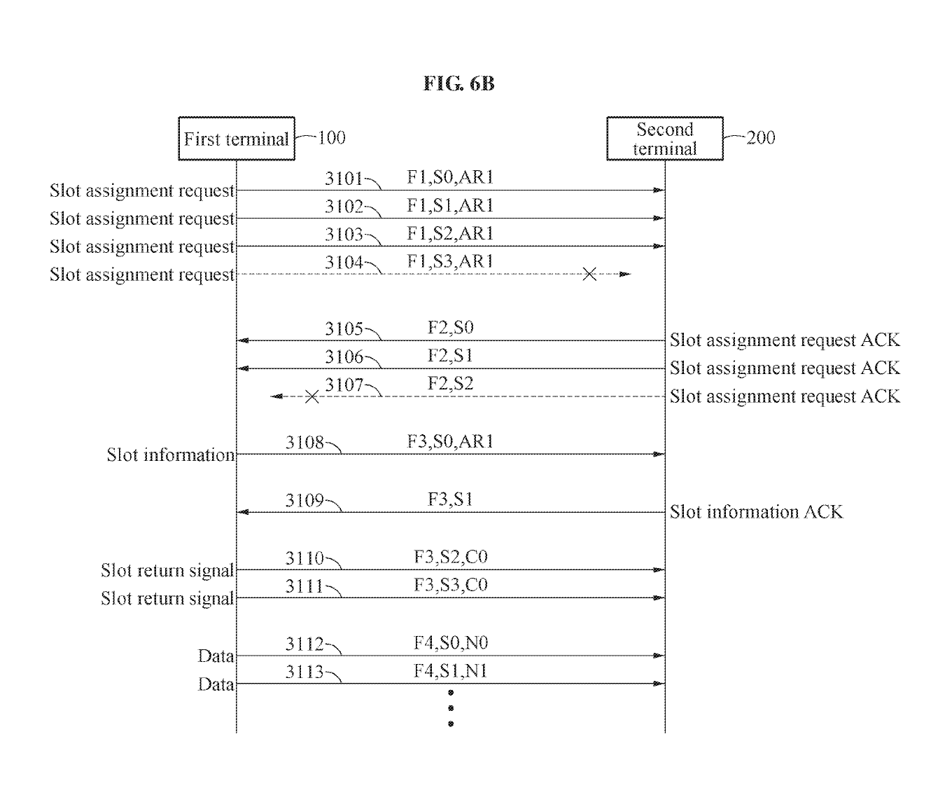

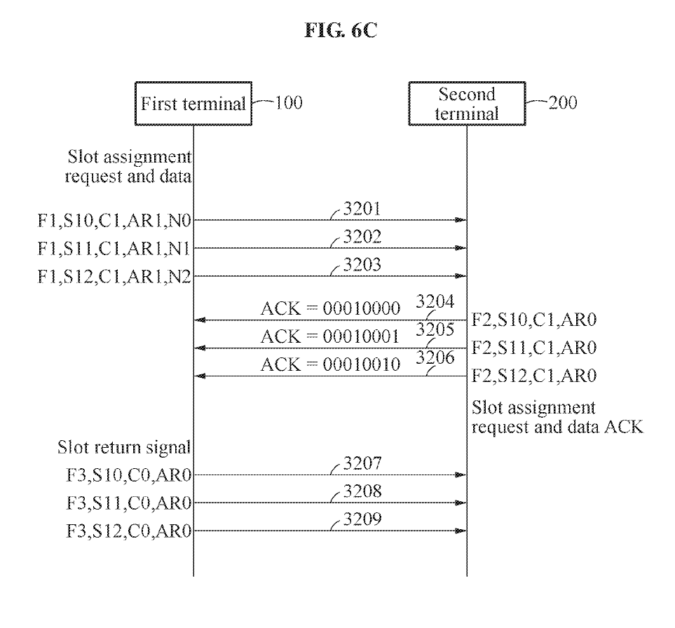

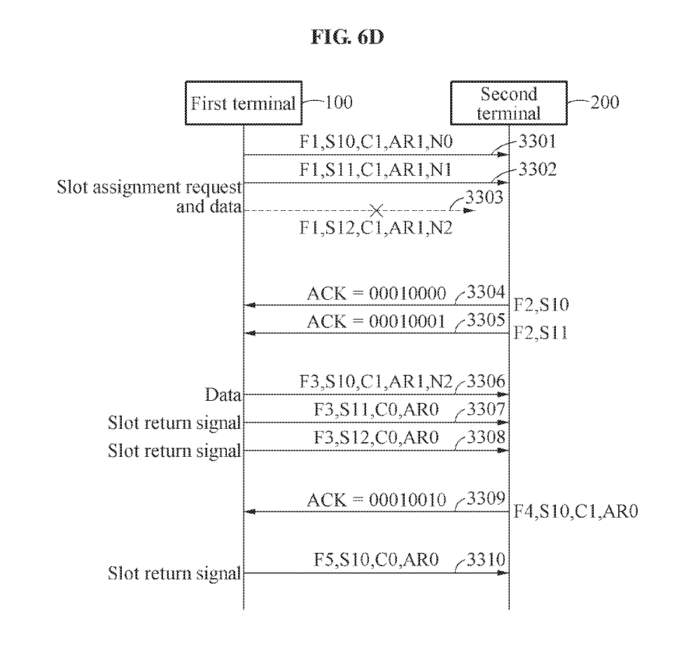

FIG. 6A is a flowchart illustrating a method of assigning a plurality of slots to a terminal according to an example embodiment. FIGS. 6B through 6D illustrate methods of assigning a plurality of slots to a terminal according to an example embodiment.

Referring to FIG. 6A, a method of assigning a plurality of slots may include operation 301 of transmitting assignment requests for a plurality of slots from the first terminal 100 to the second terminal 200, operation 302 of determining whether ACKs of the assignment requests are received, operation 303 of storing slot information of a slot when an ACK of an assignment request for the slot is received or operation 304 of transmitting a slot return signal when the ACK of the assignment request for the slot is not received, operation 305 of transmitting the slot information related to the slot for which the ACK of the assignment request is received to the second terminal 200, operation 306 of determining whether an ACK of the slot information is received from the second terminal 200, and operation 307 of using the assigned slot when the ACK of the slot information is received or operation of retransmitting the slot information to the second terminal 200 when the ACK of the slot information is not received.

That is, the method of FIG. 6A corresponds to the method of assigning a slot of FIG. 4A further including assigning a plurality of slots, operation 305 of transmitting slot information related to a slot for which an ACK of an assignment request is received to the second terminal 200, and operation 307 of using the assigned slot based on a result of operation 306 of determining whether an ACK of the slot information is received.

Operations 301, 302, and 304 are the same as operations 101, 102, and 104 described above, and thus duplicated descriptions will be omitted for conciseness. However, herein, operation 304 may be performed after operation 306 is performed.

In a case in which the ACK of the assignment request is received, the first terminal 100 may store slot information related to the slot for which the ACK of the assignment request is received, in operation 303. However, in an example, operation of storing slot information may be omitted, and operation 305 of transmitting slot information to the second terminal 200 may be performed after operation 303 is performed.

In operation 305, the first terminal 100 may transmit the stored slot information to the second terminal 200. The first terminal 100 may transmit the slot information in the slot for which the ACK of the assignment request is received. When transmitting the slot information, the first terminal 100 may also transmit a request for an ACK of the slot information (AR1).

In operation 306, the first terminal 100 may determine whether an ACK of the slot information is received from the second terminal 200. The ACK of the slot information may be transmitted in the slot for which the ACK of the assignment request is received.

In operation 307, in a case in which the ACK of the slot information is received, the first terminal 100 determines that the slot for which the ACK of the assignment request is received has been assigned, is assigned with the slot, and uses the assigned slot.

In a case in which the ACK of the slot information is not received, the first terminal 100 may retransmit the slot information to the second terminal 200.

Hereinafter, examples of operations 301 through 307 will be described in detail with reference to FIGS. 6B through 6D.

FIG. 6B illustrates a process of assigning a plurality of slots to the first terminal 100 according to an example embodiment.

Referring to FIG. 6B, in operations 3101, 3102, 3103, and 3104, the first terminal 100 transmits assignment requests for slots S0, S1, S2, and S3 of a first frame F1 to the second terminal 200, while indicating whether to use the slots continuously as continuous use (C1) and requesting ACKs (AR1), respectively.

An error may occur in transmission in the slot S3, for example, an error may occur in a receiver of the second terminal 200. In this example, the assignment request for the slot S3 transmitted from the first terminal 100 may not be transmitted to the second terminal 200.

The second terminal 200 receives the assignment requests for the slots S0, S1, and S2, but may not receive the assignment request for the slot S3. Thus, the second terminal 200 transmits ACKs of the assignment requests for the slots to the first terminal 100 in slots S0, S1, and S2 of a second frame F2 which is a subsequent frame of the first frame F1, while indicating whether to use the slots continuously as continuous use (C1) and not requesting ACKs (AR0), in operations 3105, 3106, and 3107.

An error may occur in transmission in the slot S2, for example, an error may occur in a receiver of the first terminal 100. In this example, the ACK of the assignment request for the slot transmitted from the second terminal 200 in the slot S2 may not be transmitted to the first terminal 100.

The first terminal 100 determines that the ACKs are received in the slots S0 and S1 of the second frame F2, and thus stores slot information related to the slots S0 and S1, and transmits the slot information to the second terminal 200 while requesting an ACK of the slot information (AR1), in operation 3108.

In this example, the slot information may be transmitted in the slots for which the assignment requests are received, and may be transmitted in a first slot of the slots for which the assignment requests are received.

In operation 3109, the second terminal 200 transmits an ACK of the slot information to the first terminal 100. In this example, the ACK of the slot information may be transmitted in the slots for which the assignment requests for the slots are received, and may be transmitted in a second slot of the slots for which the assignment requests are received.

The first terminal 100 determines that the ACKs are not received in the slots S2 and S3 of the second frame F2, and thus transmits slot return signals in slots S2 and S3 of a third frame F3, in operations 3110 and 3111.

The first terminal 100 is assigned with the slots S0 and S1 for which the ACKs of the assignment requests are received, and uses the slots S0 and S1, in operations 3112 and 3113.

FIG. 6C illustrates a process of transmitting a plurality of items of data along with assignment requests for a plurality of slots from the first terminal 100 according to an example embodiment.

Referring to FIG. 6C, in operations 3201, 3202, and 3203, the first terminal 100 transmits data along with assignment requests for slots S10, S11, and S12 of a first frame F1 to the second terminal 200, while indicating whether to use the slots continuously as continuous use (C1) and requesting ACKs (AR1).

The requested ACKs may include ACKs of the assignment requests for the slots and ACKs of the data.

In operations 3204, 3205, and 3206, the second terminal 200 receiving the assignment requests for the plurality of slots and the data transmits ACKs of the assignment requests for the slots and the data to the first terminal 100 in slots S10, S11, and S12 of a second frame F2 which is a subsequent frame of the first frame F1, while indicating whether to use the slots continuously as continuous use (C1) and not requesting ACKs (AR0).

The first terminal 100 determines that the ACKs of the assignment requests for the slots and the ACKs of the data are received from the second terminal 200 in the slots S10, S11, and S12 of the second frame F2.

Here, the ACKs of the data are “00010000”, “00010001”, and “00010010”. As described above, first four digits indicate a number of data having normal CRC results, and last four digits indicate a sequence number of each item of the data.

The first terminal 100 does not have data to be further transmitted after receiving the ACKs. Thus, the first terminal 100 determines that the slots S10, S11, and S12 are not to be used continuously, and returns the slots S10, S11, and S12 by transmitting slot return signals, in operations 3207, 3208, and 3209.

FIG. 6D illustrates a case in which an error occurs when the first terminal 100 transmits a plurality of items of data along with assignment requests for a plurality of slots according to an example embodiment.

Referring to FIG. 6D, in operations 3301, 3302, and 3303, the first terminal 100 transmits assignment requests for slots S10, S11, and S12 of a first frame F1 and data to the second terminal 200, while indicating whether to use the slots continuously as continuous use (C1) and requesting ACKs (AR1).

The requested ACKs may include ACKs of the assignment requests for the slots and ACKs of the data.

An error may occur in transmission in the slot S12, for example, an error may occur in a receiver of the second terminal 200. In this example, the assignment request for the slot and the data transmitted from the first terminal 100 in the slot S12 may not be transmitted to the second terminal 200.

The second terminal 200 receives the assignment requests for the slots and the data in the slots S10 and S11, but may not receive the assignment request for the slot and the data in the slot S12. Thus, in operation 3304 and 3305, the second terminal 200 transmits ACKs of the assignment requests for the slots and the data to the first terminal 100 in slots S10 and S11 of a second frame F2 which is a subsequent frame of the first frame F1, while indicating whether to use the slots continuously as continuous use (C1) and not requesting ACKs (AR0).

In this example, the first terminal 100 determines that the ACKs of the assignment requests for the slots and the ACKs of the data are received from the second terminal 200 in the slots S10 and S11 of the second frame F2, and that the ACKs are not received in the slot S12.

Since the first terminal 100 determines that the ACK of the assignment request for the slot is not received in the slot S12 of the second frame F2, the first terminal 100 determines that the slot 12 has not been assigned.

Further, the first terminal 100 determines that ACKs with respect to data of sequence numbers “0” and “1” are received in the slots S10 and S11, and that an ACK with respect to data of a sequence number “2” is not received. Thus, the first terminal 100 retransmits the data of the sequence number “2” to the second terminal 200 in an assigned slot S10 of a third frame F3 which is a subsequent frame of the second frame F2, in operation 3306.

Since the first terminal 100 does not have data to be further transmitted, the first terminal 100 determines that the slot S11 is not be to be used continuously, and returns the slot S11 by transmitting a slot return signal, in operation 3307.

Since the first terminal 100 determines that an ACK of the assignment request for the slot is not received in the slot S12 of the second frame F2, the first terminal 100 transmits a slot return signal in a slot S12 of the third frame F3, in operation 3308.

In operation 3309, the second terminal 200 receiving the data in the slot S10 transmits an ACK of the data to the first terminal 100 in the slot S10, while indicating whether to use the slot continuously as continuous use (C1) and not requesting an ACK (AR0).

Since the first terminal 100 does not have data to be further transmitted, the first terminal 100 determines that the slot S10 is not be to be used continuously, and returns the slot S10 by transmitting a slot return signal, in operation 3310.

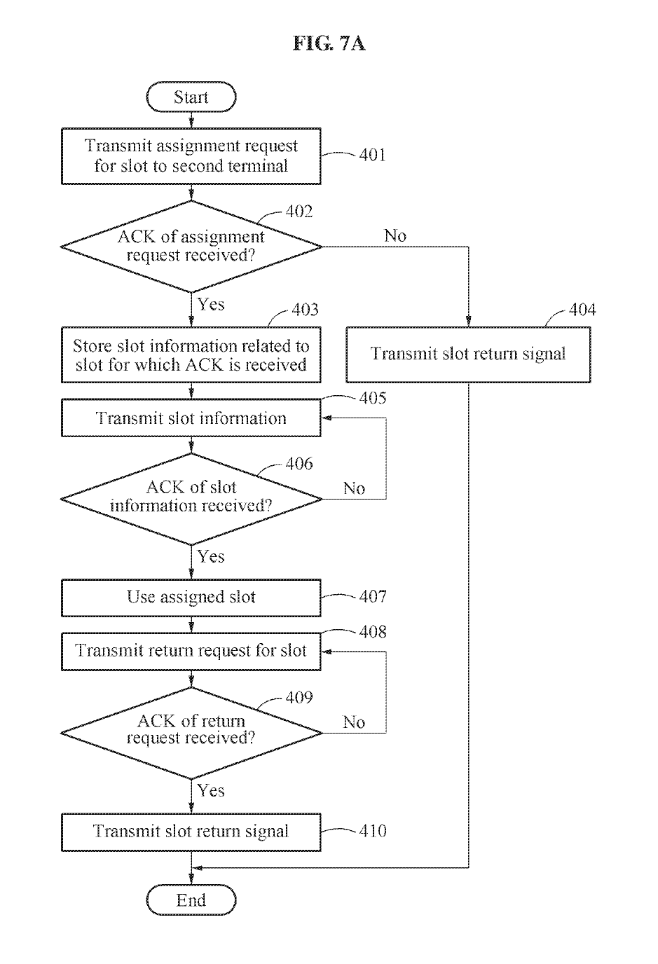

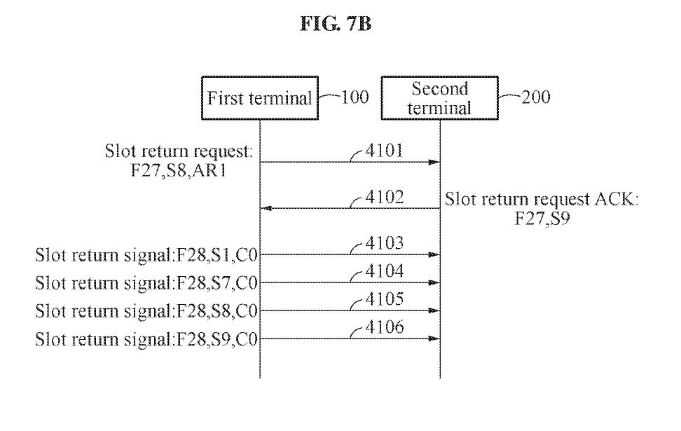

Hereinafter, a method of returning a slot in a case in which a plurality of slots are assigned and slot information is shared between the first terminal 100 and the second terminal 200 will be described with reference to FIGS. 7A and 7B.

FIG. 7A is a flowchart illustrating a method of returning an assigned slot after a plurality of slots are assigned to a terminal according to an example embodiment. FIG. 7B illustrates a process of returning an assigned slot after a plurality of slots are assigned to a terminal according to an example embodiment.

Referring to FIG. 7A, a method of assigning a plurality of slots and returning a slot may include operation 401 of transmitting assignment requests for a plurality of slots from the first terminal 100 and the second terminal 200, operation 402 of determining whether ACKs of the assignment requests are received from the second terminal 200, operation 403 of storing information related to a slot when an ACK of an assignment request for the slot is received or operation 404 of transmitting a slot return signal when the ACK of the assignment request for the slot is not received, operation 405 of transmitting the slot information related to the slot for which the ACK of the assignment request is received to the second terminal 200, operation 406 of determining whether an ACK of the slot information is received from the second terminal 200, operation 407 of using the assigned slot when the ACK of the slot information is received or operation of retransmitting the slot information to the second terminal 200 when the ACK of the slot information is not received, operation 408 of transmitting a return request for the slot to the second terminal 200, operation 409 of determining whether an ACK of the return request is received, and operation 410 of transmitting a slot return signal when the ACK of the return request is received or operation of retransmitting the return request to the second terminal 200 when the ACK of the return request is not received.

The method of FIG. 7A corresponds to the method of FIG. 6A further including operations 408 through 410. Operations 401 through 407 are the same as operations 301 through 307 described above, and thus duplicated descriptions will be omitted for conciseness.

In operation 408, the first terminal 100 may transmit a return request for at least one of slots determined to have been assigned to the second terminal 200. The first terminal 100 may transmit an ACK request for the return request along with the return request for the slot.

In operation 409, the first terminal 100 may determine whether an ACK of the return request is received from the second terminal 200.

In response to determination that the ACK of the return request has been received, the first terminal 100 may transmit a slot return signal to the second terminal 200 in the at least one slot for which the return request is transmitted, while indicating whether to use the at least one slot continuously as non-use (C0), in operation 410.

In response to determination that the ACK of the return request has not been received, the first terminal 100 may retransmit the return request for the slot to the second terminal 200.

Hereinafter, examples of operations 401 through 410 will be described with reference to FIG. 7B.

FIG. 7B illustrates a process of returning a plurality of slots assigned to the first terminal 100 according to an example embodiment.

Prior to operation 4101, slots S1, S7, S8, and S9 are already assigned to the first terminal 100. In operation 4101, the first terminal 100 transmits return requests for the assigned slots to the second terminal 200. When transmitting the return requests for the slots, the first terminal 100 may transmit ACK requests for the return requests together.

In operation 4102, the second terminal 200 receiving the return requests for the slots transmits ACKs of the return requests for the slots to the first terminal 100.

Since the ACKs of the return requests are transmitted to the first terminal 100, the first terminal 100 determines that the ACKs of the return requests for the slots are received. Thus, the first terminal 100 returns the slots by transmitting slot return signals in slots S1, S7, S8, and S9, in operations 4103, 4104, 4105, and 4106.

As described above, the slot return signals are transmitted while indicating whether to use the slots continuously as non-use (C0) and not requesting ACKs (AR0).

Although not shown in FIG. 7B, in a case in which the first terminal 100 determines that the ACKs of the return requests for the slots are not received in operation 4102, the first terminal 100 may retransmit the return requests for the slots to the second terminal 200.

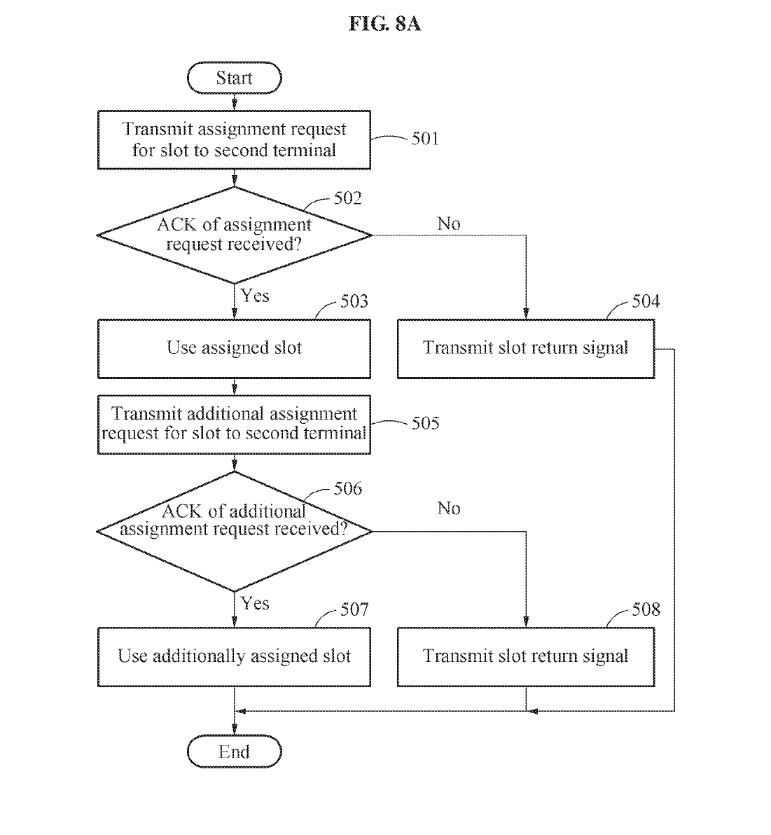

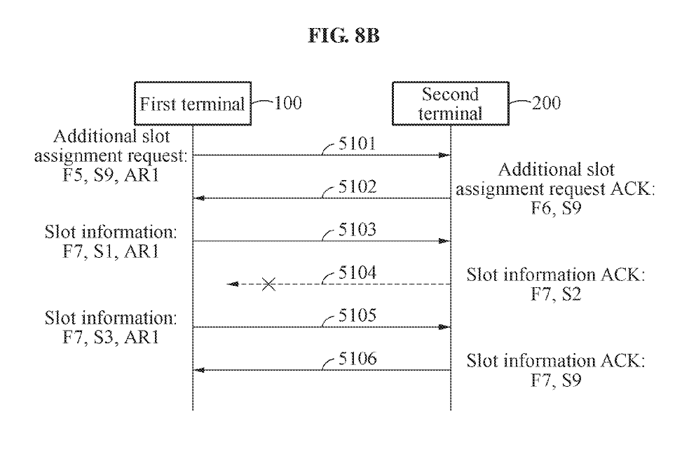

Hereinafter, a method of additionally assigning a slot after a slot is assigned to a terminal will be described with reference to FIGS. 8A and 8B.

Referring to FIG. 8A, a method of assigning a slot may include operation 501 of transmitting an assignment request for a slot from the first terminal 100 to the second terminal 200, operation 502 of determining whether an ACK of the assignment request is received from the second terminal 200, operation 503 of using the assigned slot when the ACK of the assignment request is received or operation 504 of transmitting a slot return signal when the ACK of the assignment request is not received, operation 505 of transmitting an additional assignment request for a slot from the first terminal 100 to the second terminal 200, operation 506 of determining whether an ACK of the additional assignment request is received from the second terminal 200, and operation 507 of using the additionally assigned slot when the ACK of the additional assignment request is received or operation 508 of transmitting a slot return signal when the ACK of the additional assignment request is not received.

Operations 501 through 504 are the same as operations 101 through 104 described above, and thus duplicated descriptions will be omitted for conciseness.

In operation 505, the first terminal 100 may transmit an additional assignment request for at least one slot of a fourth frame F4 to the second terminal 200.

When transmitting the additional assignment request for the slot, the first terminal 100 may indicate whether to use the slot continuously as continuous use (C1) and request an ACK of the additional assignment request for the slot (AR1).

The first terminal 100 may transmit additional assignment requests for a plurality of slots. When transmitting the additional assignment requests for the plurality of slots, the first terminal 100 may indicate whether to use the slots continuously as continuous use (C1) in the plurality of slots, and request ACKs of the additional assignment requests for the slots (AR1).

In operation 506, the first terminal 100 may determine whether an ACK of the additional assignment request is received from the second terminal 200 in a slot corresponding to the at least one slot in a fifth frame F5 which is a subsequent frame of the fourth frame F4.

A corresponding slot number in the fifth frame F5 may be the same as a slot number of the slot for which the additional assignment request is transmitted in the fourth frame F4. For example, in a case in which an assignment request for a slot is transmitted in a slot S2 of the fourth frame F4, whether an ACK of the assignment request is received in a slot S2 of the fifth frame F5 may be determined.

When the ACK of the additional assignment request is received, the first terminal 100 may determine that the slot for which the ACK is received has been additionally assigned, be additionally assigned with the slot for which the ACK is received, and use the additionally assigned slot, in operation 507.

In a case in which the first terminal 100 transmits the additional assignment requests for the plurality of slots in operation 505 and receives ACKs in a portion of the plurality of slots, the first terminal 100 may determine that the slots for which the ACKs are received have been additionally assigned, be additionally assigned with the slots for which the ACKs are received, and use the additionally assigned slots.

When the ACK of the additional assignment request is not received, the first terminal 100 may determine that the slot for which the ACK is not received has not been additionally assigned, and transmit a slot return signal to the second terminal 200, in operation 508.

In a case in which the first terminal 100 transmits additional assignment requests for a plurality of slots in operation 505 and does not receive ACKs in a portion of the plurality of slots, the first terminal 100 may determine that the slots for which the ACKs are not received have not been additionally assigned, and transmit slot return signals.

When transmitting the plurality of slot return signals, the first terminal 100 may indicate information regarding whether to use the slots continuously as non-use (C0), in the slots for which the ACKs are not received. Further, in a case in which ACKs are not received with respect to a plurality of slots, the first terminal 100 may transmit slot return signals in the plurality of slots, while indicating information regarding whether to use the slots continuously as non-use (C0).

Although not shown in FIG. 8A, in response to determination that the ACK of the additional assignment request has been received, operations 305 and 306 may be further performed before operation 507 is performed.

That is, since a plurality of slots including the additional slot are assigned, the first terminal 100 transmits slot information related to the assigned slot to the second terminal 200, and receives an ACK of the slot information.

Hereinafter, examples of operations 501 through 507 will be described with reference to FIG. 8B.

FIG. 8B illustrates a process of additionally assigning a slot to the first terminal 100 according to an example embodiment.

Prior to operation 5101, slots S1, S2, and S3 are already assigned to the first terminal 100.

Referring to FIG. 8B, in operation 5101, the first terminal 100 transmits an additional assignment request for a slot S9 of a fifth frame F5 to the second terminal 200, while indicating whether to use the slot continuously as continuous use (C1) and requesting an ACK (AR1).

In operation 5102, the second terminal 200 receiving the additional assignment request transmits an ACK of the additional assignment request to the first terminal 100 in a slot S9 of a sixth frame F6 which is a subsequent frame of the fifth frame F5, while indicating whether to use the slot continuously as continuous use (C1) and not requesting an ACK (AR0).

Since the first terminal 100 determines that the ACK is received in the slot S9 of the fifth frame F5, the first terminal 100 transmits slot information related to the slot S9 for which the ACK is received to the second terminal 200, in operation 5103.

In operation 5104, the second terminal 200 transmits an ACK of the slot information to the first terminal 100.

An error may occur in transmission in the slot S2, for example, an error may occur in a receiver of the first terminal 100. In this example, the ACK transmitted from the second terminal 200 in the slot S2 may not be transmitted to the first terminal 100.

Thus, the first terminal 100 determines that the ACK of the slot information has not been received, and retransmits the slot information to the second terminal 200 in the slot S3, in operation 5105. When transmitting the slot information, the first terminal 100 may also request an ACK of the slot information.

In operation 5106, the second terminal 200 transmits an ACK of the slot information to the first terminal 100 in the slot S9 which is a subsequent slot. Since the ACK of the additional assignment request for the slot S9 has been normally transmitted to the first terminal 100 in operation 5102, and the slot information including information indicating that the ACK of the additional assignment request has been transmitted to the first terminal 100 has been transmitted to the second terminal 200, the second terminal 200 may transmit an ACK of the slot information in the additionally assigned slot S9.

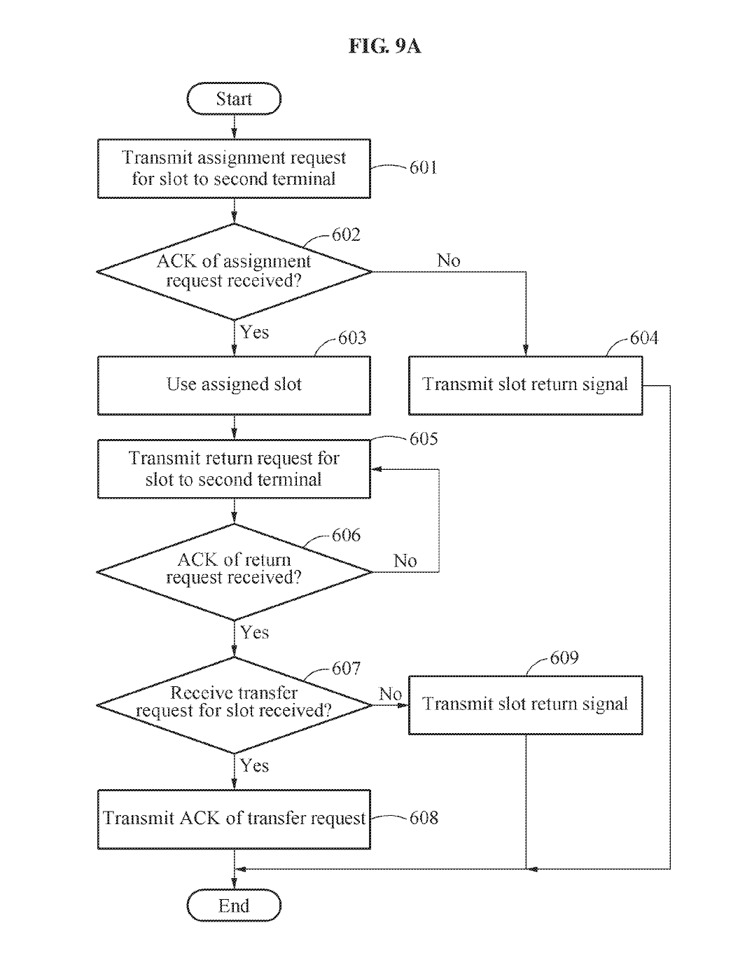

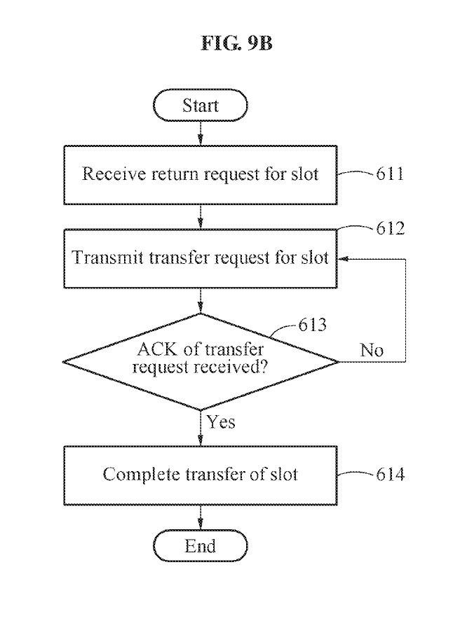

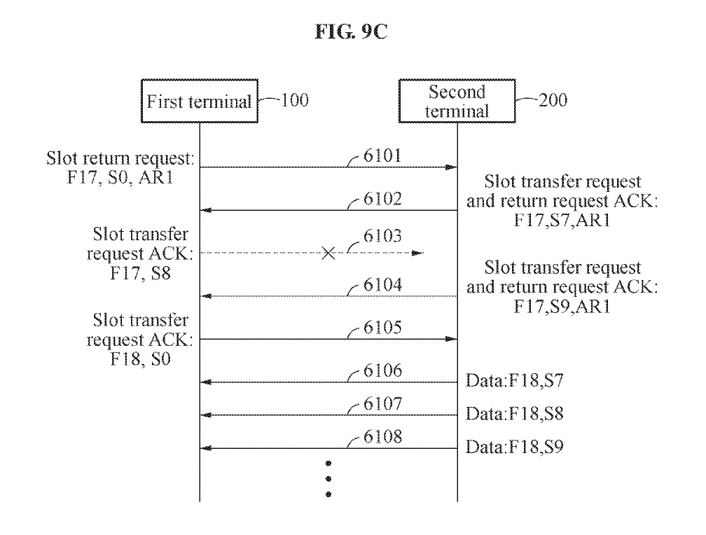

Hereinafter, a method of transferring a slot assigned to the first terminal 100 to the second terminal 200 will be described with reference to FIGS. 9A through 9C.

FIG. 9A is a flowchart illustrating a method of transferring an assigned slot from the first terminal 100 to the second terminal 200 according to an example embodiment, FIG. 9B is a flowchart illustrating a method of transferring a slot from the first terminal 100 to the second terminal 200 according to an example embodiment, and FIG. 9C illustrates a process of transferring a slot assigned to the first terminal 100 to the second terminal 200 according to an example embodiment.

Referring to FIG. 9A, a method of transferring a slot may include operation 601 of transmitting an assignment request for a slot from the first terminal 100 to the second terminal 200, operation 602 of determining whether an ACK of the assignment request is received from the second terminal 200, operation 603 of using the assigned slot when the ACK of the assignment request is received or operation 604 of transmitting a slot return signal when the ACK of the assignment request is not received, operation 605 of transmitting a return request for the slot to the second terminal 200, operation 606 of determining whether an ACK of the return request is received, operation 607 of determining whether a transfer request for the slot is received, and operation 608 of transmitting an ACK of the transfer request to the second terminal 200 when the transfer request for the slot is received or operation 609 of transmitting a slot return signal when the transfer request for the slot is not received.

Operations 601 through 604 of FIG. 9A are the same as operations 101 through 104 of FIG. 4A and operations 605 and 606 are the same as operations 408 and 409 of FIG. 7A, and thus duplicated descriptions will be omitted for conciseness.

In operation 607, the first terminal 100 may determine that whether a transfer request for a slot is received from the second terminal 200. The transfer request may be transmitted with respect to at least a portion of the slots for which the return requests are transmitted from the first terminal 100 in operation 605, and the first terminal 100 may receive the transfer request for the slot along with an ACK request for the transfer request for the slot.

In response to determination that the transfer request of the slot has been received, the first terminal 100 may transmit an ACK of the transfer request for the slot to the second terminal 200, in operation 608.

In response to determination that the transfer request for the slot has not been received, the first terminal 100 may transmit a slot return signal to the second terminal 200 in the slot for which the return request is transmitted, in operation 609.

Referring to FIG. 9B, a method of transferring a slot from the first terminal 100 to the second terminal 200 may include operation 611 of receiving a return request for a slot from the first terminal 100, operation 612 of transmitting a transfer request for the slot to the first terminal 100, operation 613 of determining whether an ACK of the transfer request for the slot is received, and operation 614 of completing the transfer of the slot when the ACK of the transfer request for the slot is received or operation of retransmitting the transfer request for the slot when the ACK of the transfer request for the slot is not received.

In operation 611, the second terminal 200 may receive a return request for the slot from the first terminal 100. Operation 611 corresponds to operation 605 of FIG. 9A. The second terminal 200 may receive an ACK request for the return request along with the return request for the slot.

In operation 612, the second terminal 200 may transmit a transfer request for the slot to the first terminal 100. Operation 612 corresponds to operation 606 of FIG. 9A. When transmitting the transfer request for the slot, the second terminal 200 may also transmit an ACK of the return request for the slot and the ACK request for the transfer request for the slot.

In operation 613, the second terminal 200 may determine whether the ACK of the transfer request for the slot is received. Operation 613 corresponds to operation 607 of FIG. 9A. The second terminal 200 may determine whether the transfer request for the slot has been transmitted based on whether an ACK of the transfer request for the slot transmitted from the first terminal 100 is received. That is, in a case in which the ACK of the transfer request is received, the second terminal 200 determines that the transfer request for the slot has been transmitted. In a case in which the ACK of the transfer request is not received, the second terminal 200 determines that the transfer request for the slot has not been transmitted.

In response to determination that the transfer request for the slot has been transmitted as the ACK of the transfer request of the slot is received, the second terminal 200 may complete the transfer of the slot and use the transferred slot, in operation 614

In response to determination that the transfer request for the slot has not been transmitted as the ACK of the transfer request of the slot is not received, the second terminal 200 may retransmit the transfer request for the slot to the first terminal 100.

Hereinafter, examples of operations 601 through 614 will be described in detail with reference to FIG. 9C.

In the example of FIG. 9C, slots S0, S7, S8, and S9 are already assigned to the first terminal 100.

In operation 6101, the first terminal 100 transmits a return request for a slot S0 to the second terminal 200.

In this example, the first terminal 100 may also transmit an ACK request for the return request for the slot to the second terminal 200.

In operation 6102, the second terminal 200 transmits, to the first terminal 100, an ACK of the return request for the slot and a transfer request for the slot for which the return request is received. When transmitting the transfer request for the slot, the second terminal 200 may indicate whether to use the slot continuously as continuous use (C1), and transmit an ACK request for the transfer request for the slot (AR1).

When the ACK of the return request for the slot, the ACK request for the transfer request for the slot, and the transfer request for the slot for which the return request is transmitted are received from the second terminal 200, the first terminal 100 transmits an ACK of the transfer request for the slot to the second terminal 200, in operation 6103. However, an error may occur when transmitting the ACK of the transfer request for the slot, for example, an error may occur in a receiver of the second terminal 200. In this example, the ACK of the transfer request for the slot transmitted from the first terminal 100 may not be transmitted to the second terminal 200. Thus, in operation 6104, the second terminal 200 retransmits, to the first terminal 100, the ACK of the return request for the slot, the ACK request for the transfer request for the slot, and the transfer request for the slot for which the return request is received.

When the ACK of the return request for the slot, the ACK request for the transfer request for the slot, and the transfer request for the slot for which the return request is transmitted are received again from the second terminal 200, the first terminal 100 transmits the ACK of the transfer request for the slot to the second terminal 200, in operation 6105.

When the ACK of the transfer request for the slot is received, the second terminal 200 completes the transfer of the slots S0, S7, S8, and S9, and transmits data using the transferred slots, in operations 6106, 6107, and 6108.

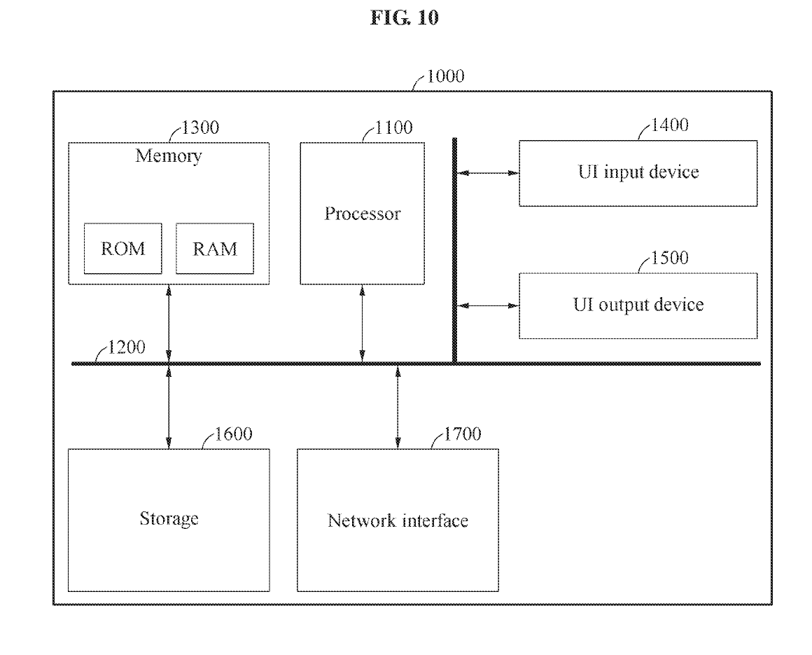

FIG. 10 is a block diagram illustrating a computing system performing a method of assigning a slot according to an example embodiment.

Referring to FIG. 10, a computing system 1000 may include at least one processor 1100 connected via a bus 1200, a memory 1300, a user interface (UI) input device 1400, a UI output device 1500, a storage 1600, and a network interface 1700.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) and a random access memory (RAM).

Thus, the operations of algorithm or method described with relation to the example embodiments disclosed herein may be implemented directly as hardware modules, software modules, or a combination of two thereof that may be executed by the processor 1100. The software modules may be resident in a storage medium such as a RAM, a flash memory, a ROM, an erasable and programmable read only memory (EPROM), an electrically erasable and programmable read only memory (EEPROM), a resister, a hard disk, a removable disk, or a compact disc read only memory (CD-ROM), that is, the memory 1300 and/or the storage 1600. The exemplary storage medium may be coupled to the processor 1100, and the processor 1100 may read data from the storage medium and write data on the storage medium. In another example, the storage medium may be integrated with the processor 1100. The processor 1100 and the storage medium may be resident in an application specific integrated circuit (ASIC). The ASIC may be resident in a user terminal. In another example, the processor 1100 and the storage medium may be resident in the user terminal as separate components.

The above-described method of assigning a slot is not limited to the configuration and the method of the example embodiments, and some or all of the example embodiments may also be selectively combined so that various modifications may be implemented.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of assigning a slot for self-organized time division multiple access (SOTDMA), the method comprising:
transmitting an assignment request for at least one slot of a first frame to a terminal;
determining whether an acknowledgement (ACK) of the assignment request is received from the terminal, in a slot corresponding to the at least one slot in a second frame which is a subsequent frame of the first frame; and
determining whether the at least one slot for which the assignment request is transmitted has been assigned based on whether the ACK of the assignment request is received.

2. The method of claim 1, wherein the ACK of the assignment request comprises a number of data having normal cyclic redundancy check (CRC) results and sequence numbers of the data having normal CRC results.

3. The method of claim 1, further comprising:
transmitting a slot return signal to the terminal, in a slot corresponding to a slot determined to have not been assigned in a third frame which is a subsequent frame of the second frame.

4. The method of claim 1, further comprising:
determining whether at least one of slots determined to have been assigned is to be used continuously; and
transmitting a slot return signal to the terminal in at least one slot determined not to be used continuously.

5. The method of claim 1, wherein the transmitting comprises transmitting data along with the assignment request for the slot,
the determining of whether the ACK of the assignment request is received comprises determining whether an ACK of the data is received,
wherein the method further comprises determining whether the data has been successfully transmitted based on whether the ACK of the data is received.

6. The method of claim 5, further comprising:
retransmitting, to the terminal, data determined to have not been transmitted, in a slot determined to have been assigned.

7. The method of claim 1, further comprising:
transmitting, to the terminal, slot information related to a slot for which an ACK of an assignment request is received;
determining whether an ACK of the slot information is received; and
determining whether the slot information has been successfully transmitted based on whether the ACK of the slot information is received.

8. The method of claim 7, further comprising:
in response to determination that the slot information has not been transmitted,
retransmitting the slot information to the terminal, in a slot determined to have been assigned.

9. The method of claim 7, further comprising:
storing the slot information related to the slot for which the ACK of the assignment request is received.

10. The method of claim 1, further comprising:
transmitting, to the terminal, a return request for at least one of slots determined to have been assigned, in a slot determined to have been assigned;
determining whether an ACK of the return request is received; and
determining whether the return request has been successfully transmitted based on whether the ACK of the return request is received.

11. The method of claim 10, further comprising:
in response to determination that the return request has not been transmitted,
retransmitting the return request to the terminal, in the slot determined to have been assigned.

12. The method of claim 10, further comprising:
in response to determination that the return request has been transmitted,
transmitting a slot return signal to the terminal, in the at least one slot for which the return request is transmitted.

13. The method of claim 1, further comprising:
transmitting an additional assignment request for at least one slot of a fourth frame;
determining whether an ACK of the additional assignment request is received from the terminal, in a slot corresponding to the at least one slot for which the additional assignment request is transmitted in a fifth frame which is a subsequent frame of the fourth frame; and
determining whether the at least one slot for which the additional assignment request is transmitted has been additionally assigned based on whether the ACK of the additional assignment request is received.

14. The method of claim 13, further comprising:
transmitting a slot return signal to the terminal, in a slot corresponding to a slot determined to have not been additionally assigned in a sixth frame which is a subsequent frame of the fifth frame.

15. The method of claim 10, further comprising:
in response to determination that the return request has been transmitted,
determining whether a slot transfer request is received; and
determining whether the at least one slot for which the return request is transmitted is to be transferred based on whether the slot transfer request is received.

16. The method of claim 15, further comprising:
in response to determination that the at least one slot for which the return request is transmitted is to be transferred,
transmitting an ACK of the slot transfer request to the terminal.

17. The method of claim 15, further comprising:
in response to determination that the at least one slot for which the return request is transmitted is not to be transferred,
transmitting a slot return signal to the terminal, in the at least one slot for which the return request is transmitted.

18. A method of transferring a slot for self-organized time division multiple access (SOTDMA), the method comprising:
receiving a return request for at least one slot;
transmitting, to a terminal, a slot transfer request for at least one of slots for which return requests are received;
determining whether an acknowledgement (ACK) of the slot transfer request is received; and
determining whether the slot transfer request has been successfully transmitted based on whether the ACK of the slot transfer request is received.

19. The method of claim 18, further comprising:
in response to determination that the slot transfer request has not been transmitted,
retransmitting the slot transfer request to the terminal.
